(19) United States
(12) Patent Application Publication
(10) Pub. No.: US 2010/0135746 A1
(43) Pub. Date: Jun. 3, 2010

(54) CONNECTING BOLT

(76) Inventor: Kaoru Taneichi, Kanagawa (JP)

Correspondence Address: JORDAN AND HAMBURG LLP, 122 EAST 42ND STREET, SUITE 4000, NEW YORK, NY, 10168, US

(21) Appl. No.: 12/597,086

(22) PCT Filed: May 2, 2007
(86) PCT No.: PCT/JP2007/059357

§ 371 Date: Oct. 22, 2009

(51) Int. Cl. F16B 25/00

(52) U.S. Cl. 411/386

(57) ABSTRACT

A connecting bolt has: a screw rod which has threads in outer circumference part; a guidepost which is integrally formed so that the guidepost projects from a tip part of the screw rod, and which is the same outer diameter size as the root diameter of a thread, or is outer diameter size smaller than the root diameter of a thread; a shavings insertion hole which is formed in the guidepost and the screw rod; a tap part which is formed in a thread near the guidepost; a notch which is provided at least two or more, guides shavings into the shavings insertion hole, and is formed in the tap part and the guidepost; and a connecting means of the shape of a bolt or a nut which is integrally formed in the back end part of the screw rod.

And the connecting bolt can attach to the pillar and the beam of a timber material easily, and the fixed state at the time of attachment is not visible from outside, and makes appearance beautiful.

### BACKGROUND OF THE INVENTION

The present invention relates to a connecting bolt which is used embedded to a pillar and a beam of a timber material when a bolt fixes the pillar and the beam.

Conventionally, a strap bolt is used when the pillar and the beam of a timber material are fixed.

However, the attachment portion of the nut of the tip part of the strap bolt and the board portion having the bolt insert hole of a strap bolt project the outside of the pillar or the beam, and are unsightly.

Reference document: JP, 2001-12442, A

### SUMMARY OF THE INVENTION

An object of the present invention is to supply a connecting bolt which can attach to the pillar and the beam of a timber material easily, which does not appear to the outside as for the fixed state, and which makes appearance beautiful.

The present invention is understood to encompass embodiments which include all or only a portion of the above objects, features and advantages which, unless recited in claims defining the invention, are understood not to limit interpretation of such claims. The above, and other objects, features and advantages of the present invention will become apparent from the following description read in conjunction with the accompanying drawings, in which like reference numerals designate the same elements. It is to be expressly understood, however, that the drawings are for the purpose of illustration and description only, and are not intended as a definition of the limits of the invention.

In order to achieve the above mentioned purpose, the present invention comprises: a screw rod which has threads in outer circumference part; a guidepost which is integrally formed so that the guidepost projects from a tip part of the screw rod, and which is the same outer diameter size as the root diameter of a thread, or is outer diameter size smaller than the root diameter of a thread; shavings insertion hole which is formed in the guidepost and the screw rod; a tap part which is formed in a thread near the guidepost; a notch which is provided at least two or more, and which guides shavings into the shavings insertion hole formed in the tap part and the guidepost; and a connecting means of the shape of a bolt or a nut which is integrally formed in the back end part of the screw rod.

According to another aspect of the invention, the present invention comprises: a screw rod which has threads in outer circumference part; a tap part which is formed in a tip part of the screw rod so that the tip part side becomes a smaller diameter in turns; a guidepost which is integrally formed so that the guidepost projects from a tip part of the tap part, and which is the same outer diameter size as the root diameter of a tap, or is outer diameter size smaller than the root diameter of the tap; a shavings insertion hole which is formed in the guidepost, the tap part, and the screw rod; a notch which is provided at least two or more, and which guides shavings into the shavings insertion hole formed in the guidepost and the tap part; and a connecting means of the shape of a bolt or a nut which is integrally formed in the back end part of the screw rod.

According to another aspect of the invention, the present invention comprises: a screw rod which has the thread in the outer circumference part; a guidepost which is integrally formed so that the guidepost projects from a tip part of the screw rod, and which is the same outer diameter size as the root diameter of a thread, or is outer diameter size smaller than the root diameter of the thread; a shavings insertion hole which is formed in the guidepost and the screw rod; a tap part which is formed in the thread near the guidepost; a notch which is provided at least two or more, and which guides shavings into the shavings insertion hole formed in the tap part and the guidepost; a connecting means of the shape of a nut which is integrally formed in a back end part of the screw rod so that the connecting means of the shape of a nut links to the shavings insertion hole; and a screw hole which is formed in an inner wall of the guidepost, or in an inner wall of the guidepost and the shavings insertion hole.

### Effect of the Invention

As is clear from the above-mentioned explanations, the present invention as hereinabove defined provides the effects enumerated below.

(1) The present invention comprises: a screw rod which has the thread in the outer circumference part; a guidepost which is integrally formed so that the guidepost projects from a tip part of the screw rod, and which is the same outer diameter size as the root diameter of a thread, or is outer diameter size smaller than the root diameter of the thread; a shavings insertion hole which is formed in the guidepost and the screw rod; a tap part which is formed in the thread near the guidepost; a notch which is provided at least two or more, and which guides shavings into the shavings insertion hole formed in the tap part and the guidepost; and a connecting means of the shape of a bolt or a nut which is integrally formed in the back end part of the screw rod. Therefore, the present invention can guide the screw rod easily by the guidepost of the tip part of the screw rod, along the hole formed in the pillar and the beam of a timber material by the drill.

(2) As described in the above (1), the tap part is formed in the thread of the screw rod near the guidepost. Therefore, when the screw rod rotates, the tap part forms the thread in the drilled hole formed in the pillar or the beam. And since the shavings which comes out when forming the thread is guided into a shavings insertion hole from the notch, the thread is formed smoothly and finely.

(3) As described in the above (1), the tap part is formed in the thread of the screw rod near the guidepost. Therefore, since the tap part formed is a few, the cost of manufacture is comparatively cheap.

(4) As described in the above (1), when a screw rod inserts in the drilled hole formed in the pillar or the beam, an electric tool or a nut is connected to the connecting means of a screw rod. Then, the screw rod is screwed forming a screw hole, an electric tool is detached from the connecting means, and the bolt or the nut can be attached to the screw rod.

(5) Claim 2 provides the same effects as those described in the above (1) to (4).

(6) Claim 3 provides the same effects as those described in the above (1) to (4), and can connect a bolt to the tip part and back end part of a screw rod.

### BRIEF DESCRIPTION OF THE DRAWINGS

FIG. 1 is a front view of a first preferred embodiment to practice the present invention.

FIG. 2 is a plan view of a first preferred embodiment to practice the present invention.

FIG. 3 is a bottom view of a first preferred embodiment to practice the present invention.

FIG. 4 is a side view of a first preferred embodiment to practice the present invention.

FIG. 5 is a sectional view along the line 5-5 of FIG. 2.

FIG. 6 is an illustration of the state of having formed the drilled hole in the pillar of the first preferred embodiment to practice the present invention.

FIG. 7 is an illustration of the state having attached the electric tool to the connecting means of the first preferred embodiment to practice the present invention.

FIG. 8 is an illustration of the state of making the connecting bolt screwing in the pillar of the first preferred embodiment to practice the present invention.

FIG. 9 is an illustration of usage state of the first preferred embodiment to practice the present invention.

FIG. 10 is an illustration of different usage state of the first preferred embodiment to practice the present invention.

FIG. 11 is an illustration of different usage state of the first preferred embodiment to practice the present invention.

FIG. 12 is a front view of a second preferred embodiment to practice the present invention.

FIG. 13 is a plan view of a second preferred embodiment to practice the present invention.

FIG. 14 is a bottom view of a second preferred embodiment to practice the present invention.

FIG. 15 is a side view of a second preferred embodiment to practice the present invention.

FIG. 16 is a sectional view along the line 16-16 of FIG. 13.

FIG. 17 is a front view of a third preferred embodiment to practice the present invention.

FIG. 18 is a plan view of a third preferred embodiment to practice the present invention.

FIG. 19 is a bottom view of a third preferred embodiment to practice the present invention.

FIG. 20 is a side view of a third preferred embodiment to practice the present invention.

FIG. 21 is a sectional view along the line 21-21 of FIG. 18.

FIG. 22 is an illustration of the state of having connected with the electric tool of the third preferred embodiment to practice the present invention.

FIG. 23 is an illustration of the state of rotating with the spanner of the third preferred embodiment to practice the present invention.

FIG. 23 is an illustration of the state of connecting a bolt of the third preferred embodiment to practice the present invention.

FIG. 25 is a front view of a fourth preferred embodiment to practice the present invention.

FIG. 26 is a plan view of a fourth preferred embodiment to practice the present invention.

FIG. 27 is a bottom view of a fourth preferred embodiment to practice the present invention.

FIG. 28 is a side view of a fourth preferred embodiment to practice the present invention.

FIG. 29 is a sectional view along the line 29-29 of FIG. 26.

FIG. 30 is a front view of a fifth preferred embodiment to practice the present invention.

FIG. 31 is a plan view of a fifth preferred embodiment to practice the present invention.

FIG. 32 is a bottom view of a fifth preferred embodiment to practice the present invention.

FIG. 33 is a side view of a fifth preferred embodiment to practice the present invention.

FIG. 34 is a sectional view along the line 34-34 of FIG. 31.

FIG. 35 is a front view of a sixth preferred embodiment to practice the present invention.

FIG. 36 is a plan view of a sixth preferred embodiment to practice the present invention.

FIG. 37 is a bottom view of a sixth preferred embodiment to practice the present invention.

FIG. 38 is a side view of a sixth preferred embodiment to practice the present invention.

FIG. 39 is a sectional view along the line 39-39 of FIG. 36.

1, 1A, 1B, 1C, 1D, 1E: Connecting bolt,
2: Thread,
3: Screw Rod,
4: Guidepost,
5: Shavings Insertion Hole,
6: Blade,
7, 7A: Tap part,
8: Notch,
9, 9A: Connecting means,
10: Pillar,
11, 11A: Drilled hole,
12: Electric tool,
13: Screw,
14: Base,
15: Anchor bolt,
16: Beam,
17: Strap bolt,
18: Bolt,
19: Nut,
20: Spanner,
21: Long Nut,
22: Screw Hole,
23: Crossbeam.

### DETAILED DESCRIPTION OF THE PREFERRED INVENTION

Preferred embodiments to practice the present invention will now be described in detail below referring to the accompanying drawings.

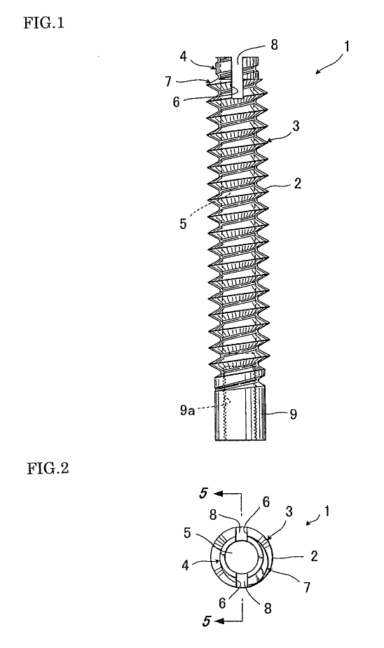

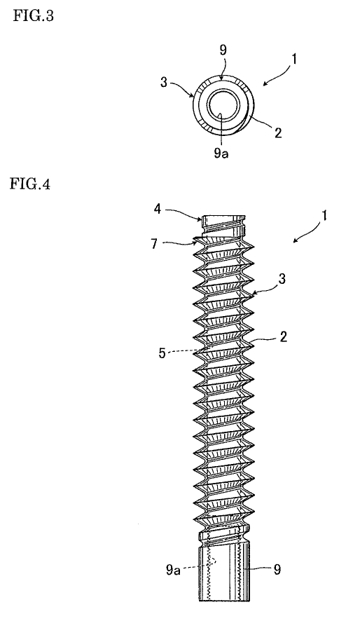

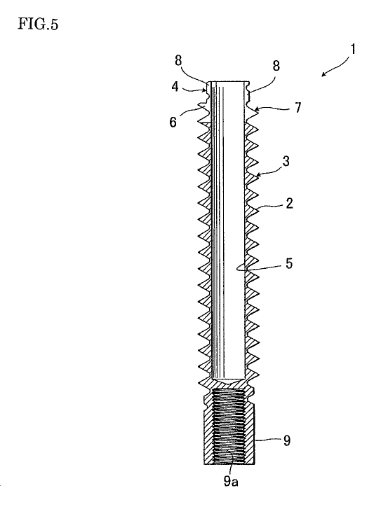

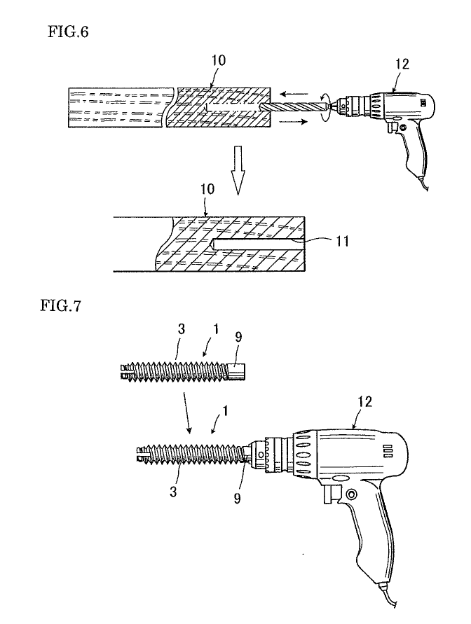

FIG. 1 to FIG. 11 illustrate a first embodiment to practice the present invention wherein 1 is a connecting bolt used when the connecting bolt fixes the pillar and the beam of a timber material.

The connecting bolt 1 comprises: a screw rod 3 which has the thread 2 in the outer circumference part; a guidepost 4 which is integrally formed so that the guidepost projects from a tip part of the screw rod 3, and which is the same outer diameter size as the root diameter of the thread 2, or is outer diameter size smaller than the root diameter of the thread 2; a shavings insertion hole 5 which is formed in the guidepost 4 and the screw rod 3; a tap part 7 which formed one piece or two or more blades 6, 6 in the thread 2 near the guidepost 4, and in an embodiment of the invention, the number of blades is even; notches 8, 8 which are provided at least two or more, guide shavings into the shavings insertion hole, and are formed in the tap part and the guidepost, and in an embodiment of the invention, notches are formed in two parts facing each other; a connecting means 9 of the shape of a nut which is integrally formed in the back end part of the screw rod 3, and which can connect detachably a rotary tool, such as an electric tool, a spanner, a box wrench, and a driver, or can be connected to a bolt, and so on.

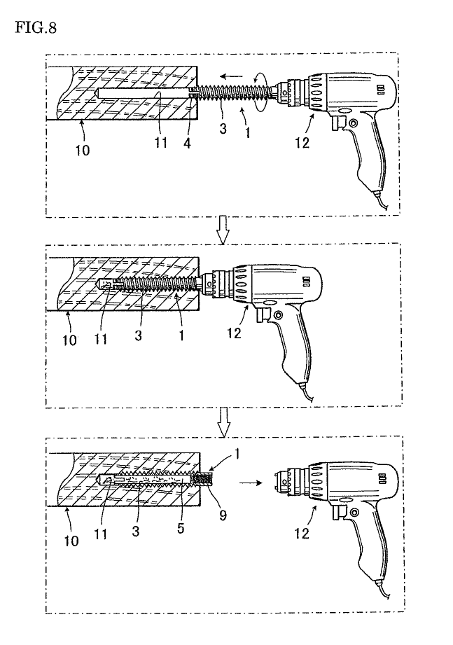

As shown in FIG. 6 and FIG. 7, when the drilled hole 11 is formed in the center part of the lower end part of the pillar 10, the electric tool 12 is attached to the connecting means of the connecting bolt 1. And as shown in FIG. 8, the guidepost 4 is inserted in drilled hole 11, the electric tool 12 drives, and connecting bolt 1 is pushed in. And the tap part 7 of the tip part is inserted, screwing forming the screw 13 in the inner wall of the drilled hole 11.

In this case, the shavings which comes out when the tap part 7 forms the screw 13 is guided into the shavings insertion hole 5 from notches 8, 8. And the screw rod 3 is screwing, forming smoothly and finely the screw 13.

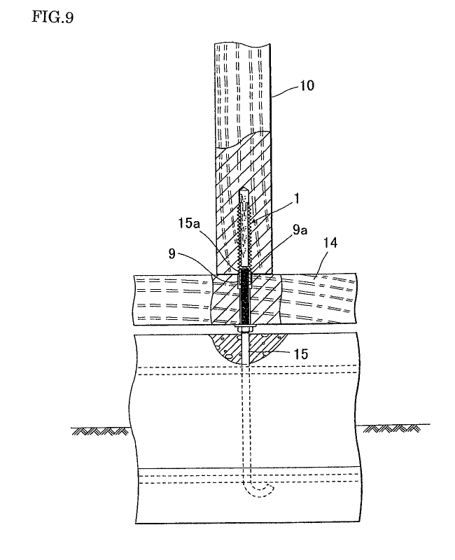

And as shown in FIG. 9, when the connecting bolt is inserted screwing in the drilled hole 11, the electric tool 12 is detached from the connecting means 9. Then, a threaded portion 15a of an anchor bolt 15 which projects on a base 14 is fixed to a screw hole 9a of the nut of the connecting means 9 of the connecting bolt 1 inserted screwing in the pillar 10 by rotating the pillar 10. And the base 14 is fixed to the pillar 10 by the anchor bolt 15 and the connecting bolt 1.

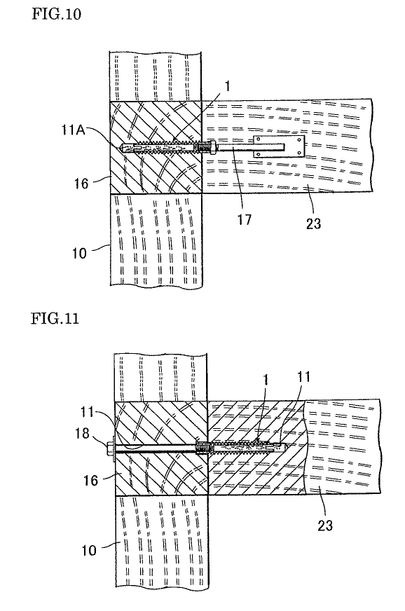

And as shown in FIG. 10, when the drilled hole 11A which does not project outside is formed in the beam 16, the connecting bolt is fixed screwing to the drilled hole and is fixed to the crossbeam 23 by the strap bolt 17.

And as shown in FIG. 11, when the drilled hole 11 is generally formed in the center part of the edge of the crossbeam 23, the connecting bolt is fixed screwing to the drilled hole and is fixed to the beam 16 having the drilled hole 11 by the bolt 18.

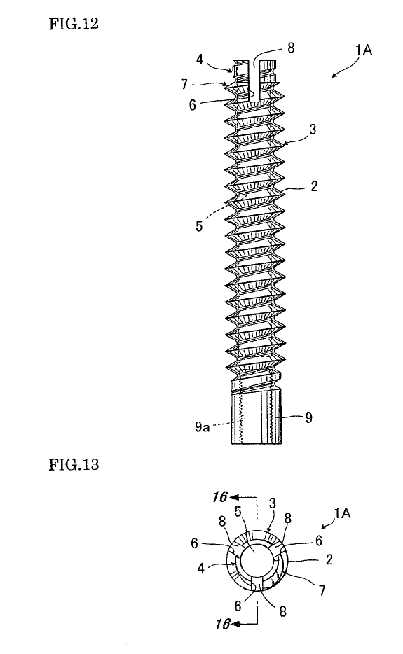

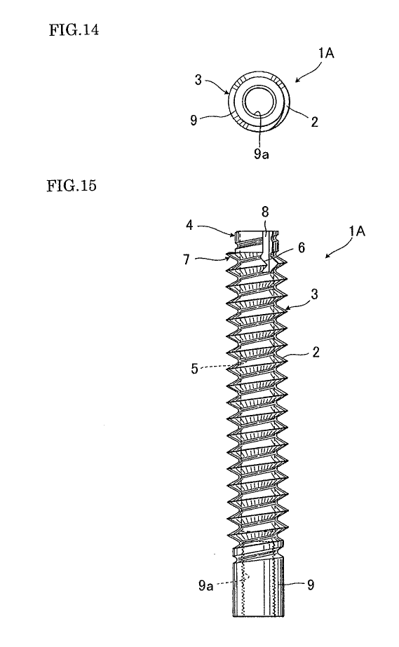

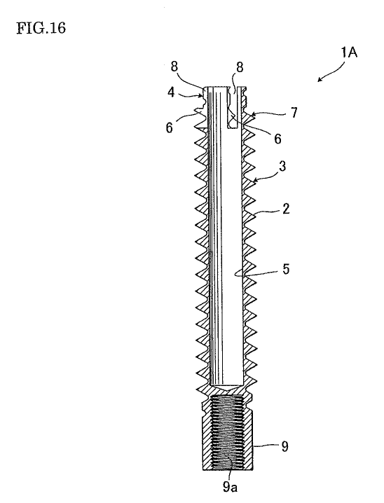

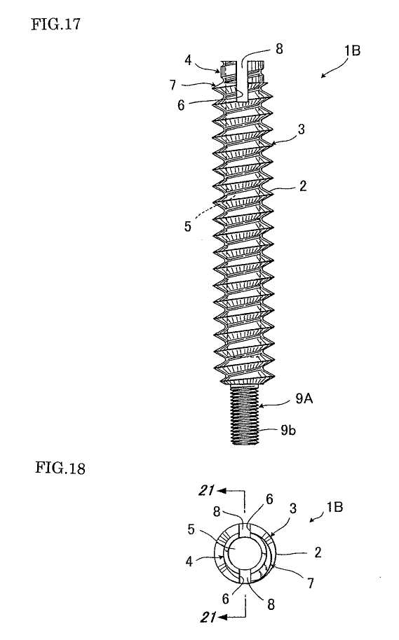

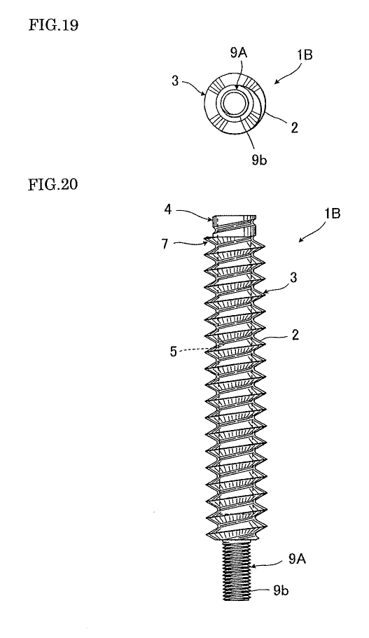

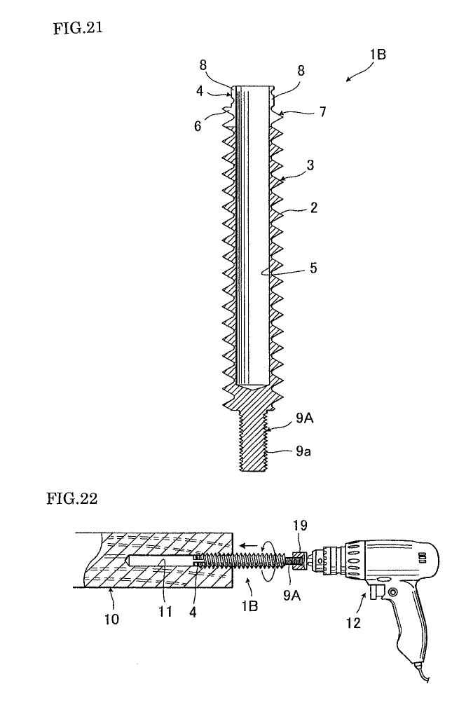

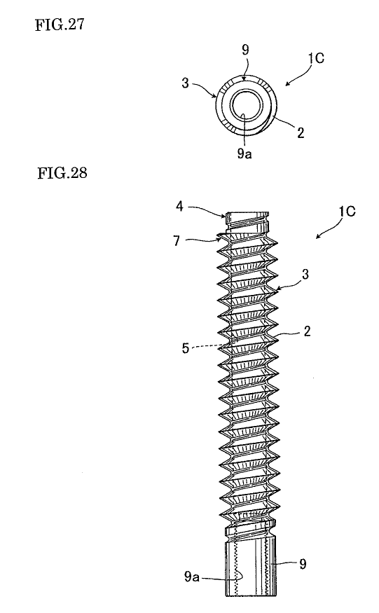

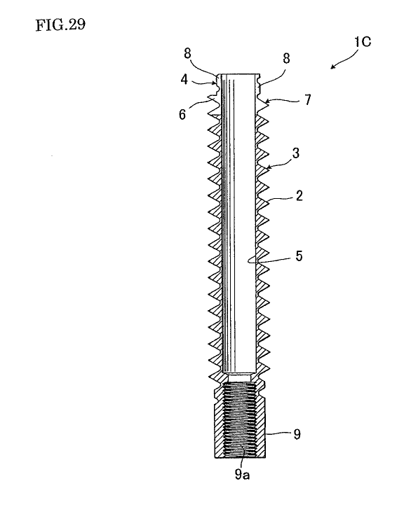

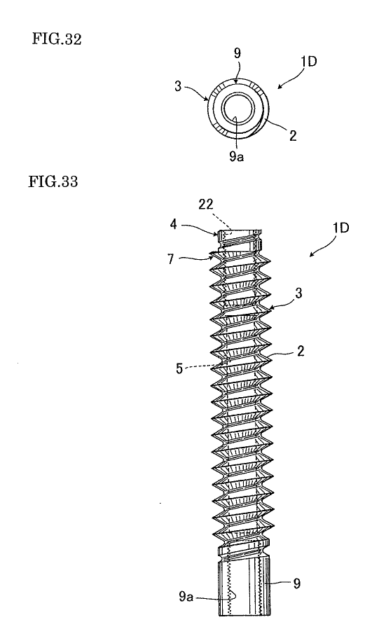

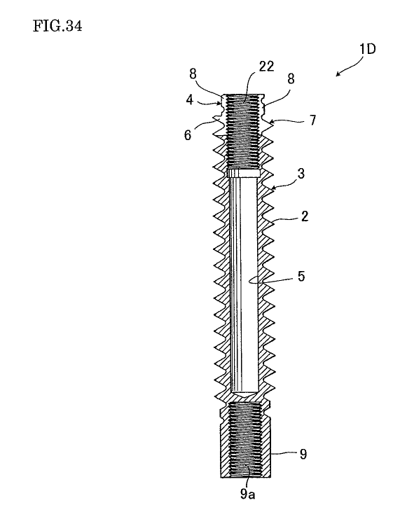

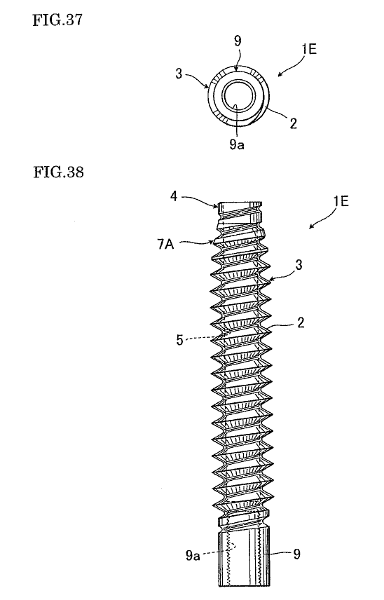

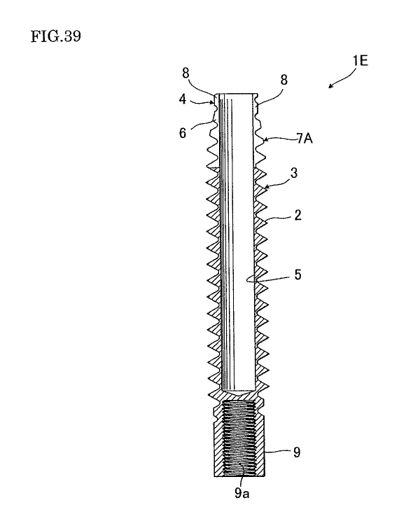

Explained next are other embodiments to practice the present invention as illustrated in FIGS. 12 to 39. In explaining these other embodiments to practice the present invention, the same component parts as those in the first preferred embodiment to practice the present invention, are given the same numerals in order to avoid the overlapping explanations.

A second embodiment to practice the present invention is shown in FIGS. 12 to 16. It is distinguished from the first preferred embodiment that: notches 8, 8, 8 are formed in three places at equal intervals at the guidepost 4 and the tap part 7 so that the odd number of blades 6, 6, 6 are formed. Therefore, a connecting bolt 1A has three notches 8, 8, 8. A connecting bolt 1A constructed as the above will have similar action effects to that according to the first preferred embodiment to practice the present invention.

A third embodiment to practice the present invention is shown in FIGS. 17 to 24. It is distinguished from the first preferred embodiment that: a connecting means 9A of a bolt shape is used.

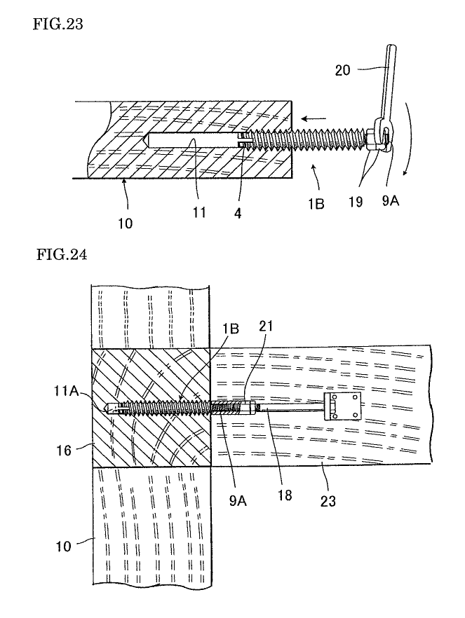

As shown in FIG. 22, when making the screw rod screw in the pillar and so on, a nut 19 screwed in a bolt 9b of the connecting means 9A is attached to the electric tool 12. And as shown in FIG. 23, two nuts 19, 19 are screwed in the connecting means 9A, and nuts are rotated by spanner 20. And as shown in FIG. 24, the connecting means 9A, of the connecting bolt 1B is connected to the bolt 18 by a long nut 21 longer than the connecting means 9A.

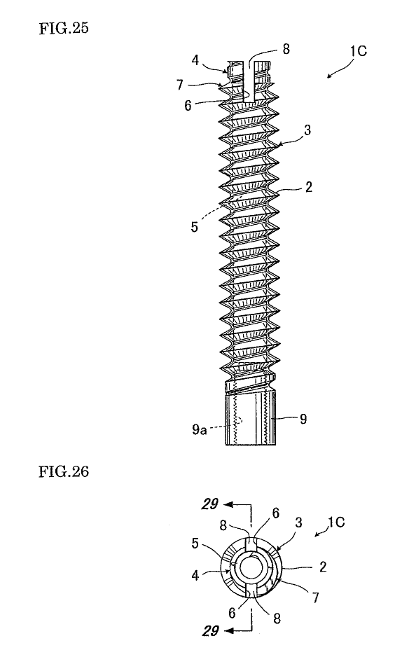

A forth embodiment to practice the present invention is shown in FIGS. 25 to 29. It is distinguished from the first preferred embodiment that: a screw hole 9a of the connecting means 9 is linking to the shavings insertion hole 5 formed in the screw rod 3. A connecting bolt 1C constructed as the above will have similar action effects to that according to the first preferred embodiment to practice the present invention. And shavings are removed from the screw hole 9a of the connecting means 9, without detaching the connecting bolt 1C which is screwed in a timber material.

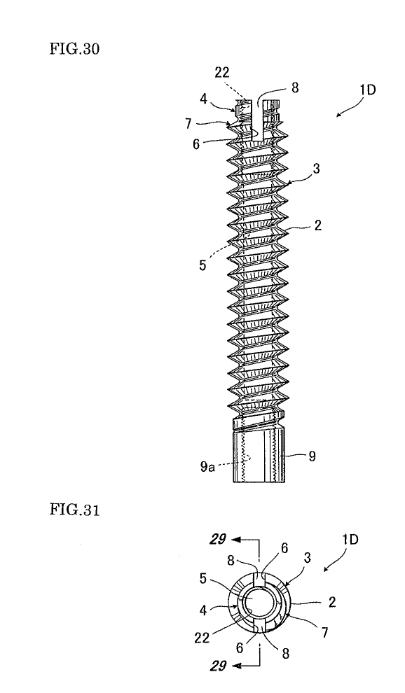

A fifth embodiment to practice the present invention is shown in FIGS. 30 to 34. It is distinguished from the first preferred embodiment that: a screw hole 2 for connecting to the bolt 18 is formed in the inner wall of shavings insertion hole 5 including the guidepost 4 and the tap part 7. A connecting bolt in which has the screw hole 22 can connect the bolts 18, 18 to the tip part and the back end part.

Further, the screw hole 22 which is connected to the bolt 18 may be formed only in the guidepost 4, or in the guidepost 4 and the tap part 7.

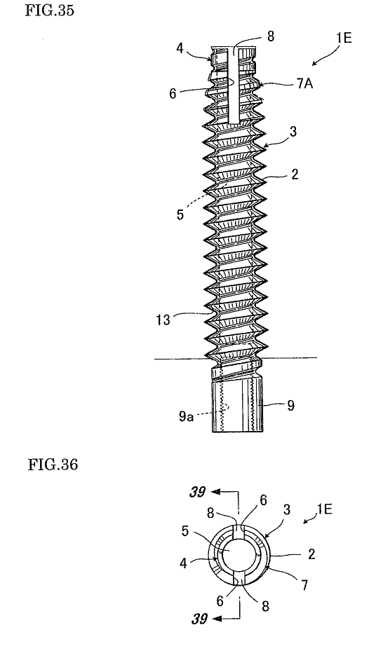

A sixth embodiment to practice the present invention is shown in FIGS. 35 to 39. It is distinguished from the first preferred embodiment that: the tap part 7A is formed so that the guidepost 4 side might become a smaller diameter in turns. A connecting bolt 1E constructed as the above will have similar action effects to that according to the first preferred embodiment to practice the present invention.

And the screw rod 3 is screwed in the screw 13, forming the screw by small drag.

In an embodiment to practice the present invention, it is explained that a connecting bolt is rotated by electric tool 12.

Further, in the present invention, a connecting bolt may be rotated by a spanner, a box wrench, a driver and so on.

The present invention is applicable in the industry of producing connecting bolts used when the bolt fixes the pillar and the beam of a timber material.

What is claimed is:

1. A connecting bolt comprising: a screw rod which has threads in outer circumference part; a guidepost which is integrally formed so that said guidepost projects from a tip part of said screw rod, and which is the same outer diameter size as the root diameter of a thread, or is outer diameter size smaller than the root diameter of a thread; a shavings insertion hole which is formed in said guidepost and said screw rod; a tap part which is formed in a thread near said guidepost; a notch which is provided at least two or more, guides shavings into said shavings insertion hole, and is formed in said tap part and said guidepost; and a connecting means of the shape of a bolt or a nut which is integrally formed in the back end part of said screw rod.

2. A connecting bolt comprising: a screw rod which has threads in outer circumference part; a tap part which is formed in a tip part of said screw rod so that a tip part side might become a smaller diameter in turns; a guidepost which is integrally formed so that said guidepost projects from a tip part of said tap part, and which is the same outer diameter size as the root diameter of a tap, or is outer diameter size smaller than the root diameter of a tap; a shavings insertion hole which is formed in said guidepost, said tap part, and said screw rod; a notch which is provided at least two or more, and which guides shavings into said shavings insertion hole formed in said guidepost and said tap part; and a connecting means of the shape of a bolt or a nut which is integrally formed in the back end part of said screw rod.

3. A connecting bolt comprising: a screw rod which has threads in outer circumference part; a guidepost which is integrally formed so that said guidepost projects from a tip part of said screw rod, and which is the same outer diameter size as the root diameter of a thread, or is outer diameter size smaller than the root diameter of a thread; a shavings insertion hole which is formed in said guidepost and said screw rod; a tap part which is formed in a thread near said guidepost; a notch which is provided at least two or more, and which guides shavings into said shavings insertion hole formed in said tap part and said guidepost; a connecting means of the shape of a bolt or a nut which is integrally formed in a back end part of said screw rod so that said connecting means of the shape of a nut links to said shavings insertion hole; and a screw hole which is formed in an inner wall of said guidepost, or in an inner wall of said guidepost and said shavings insertion hole.
